(19) United States
(12) Patent Application Publication
(10) Pub. No.: US 2004/0058043 A1
(43) Pub. Date: Mar. 25, 2004

(54) Portable cleaning and filtering apparatus

(76) Inventor: Ronald More, Gisborne (NZ)

Correspondence Address: YOUNG & THOMPSON, 745 SOUTH 23RD STREET 2ND FLOOR, ARLINGTON, VA, 22202

(21) Appl. No.: 10/253,694

(22) Filed: Sep. 25, 2002

(51) Int. Cl. A47J 37/12

(52) U.S. Cl. 426/438; 99/408

(57) ABSTRACT

Cleaning and oil filtering apparatus for removal of all solid waste material from a container generally containing hot cooking oil and for filtering the cooking oil, includes a pump, by which the cooking oil can be moved through an intake insertable at the bottom of the container, a holding tank for temporary storage of cooking oil filtered through the filtering elements, and a discharge insertable in the container and through which cooking oil from the holding tank can be discharged or cooking oil from the container can be moved through the intake and filtering elements, and discharged to the container.

### BACKGROUND TO THE INVENTION

This invention relates to portable cleaning and filtering apparatus.

More particularly the present invention relates generally to a portable apparatus designed to accomplish the rapid and efficient removal of all solid contaminants from a vessel containing liquid such as cooking oil.

Edible cooking oil (often referred to as fat or oil) may be derived from both animal and vegetable sources in solid or liquid form. It is extensively used in the food industry to cook various comestibles.

Fryers are extensively used in the food industry to contain deep, hot cooking oil, in which to cook a wide variety of food which may involve the comestible floating free or being contained in metal wire baskets. In the process, food particles, including batter scraps or breading break off and float free in the fryer to later sink unnoticed in the cooking oil, despite diligent efforts to remove them by the operator. Similarly, small potato fries and other whole food items may escape and descend unnoticed to the bottom of the fryer. As a result, it is not uncommon for several litres of such solid, submerged food waste to accumulate in the lower regions of the fryer awaiting discovery when the fryer is drained of cooking oil for cleaning purposes.

The cooking and heating process continually alters and degrades the physical and chemical properties of cooking oil, which includes the production of free fatty acids. This deterioration is exacerbated if particles dislodged from the food during the cooking process etc are permitted to remain in the hot fryer for an excessive period. This results in reduction of the useful life of the cooking oil. It can also cause a rancid taste to be imparted to the food produced, which loses it's fresh crispness.

The generation of smoke, foul odour and a lowering of the ignition flash point also accompanies such deterioration of cooking oil.

To beneficially affect the undesirable production of free fatty acids in the cooking oil, it is therefore necessary to minimise the surface area of all food waste particles, suspended or otherwise, that are in contact with the cooking oil. Particles of the size of two microns and larger should be removed from the cooking oil as regularly as practicable.

It has been found that keeping the cooking oil clean by:—

1. regularly removing the solid, submerged food waste and

2. filtering the cooking oil on a regular basis, tends to extend the useful life of the cooking oil and increase the quality and appearance of foods which are cooked therein.

The fryer must be drained regularly to permit thorough cleaning, including the removal of carbon deposits on the internal walls of the fryer tank and the removal and discarding of the larger solid food waste that has accumulated on the bottom of the fryer. Where the quantities of food being cooked are large, this cleaning process may have to be carried out several times in a 24 hour period.

The construction of fryers varies widely. For example, hot cooking oil may need to be drained through a drain hole of less than 20 mm inside diameter. Through this aperture as much as 50 litres of cooking oil may need to be removed. In such cases, the flow of the cooking oil can be severely impeded by the presence of the solid submerged food waste previously described.

In addition, certain large electric fryers, generally of older construction and also similar bench mounted models of more recent manufacture, do not allow for the removal of the heating elements to facilitate cleaning. These elements typically extend over virtually all the surface area of the base of the fryer. Where the operator is faced with a heavy accumulation of solid submerged food waste in these type of fryers, the time required to clean a fryer is considerably extended because direct access to scoop out the solid contaminants is extremely limited.

Gas fryers too are not exempt from inadequate sized drain pipes and difficulties of access, particularly where the burner elements are housed in metal tubes passing close together through the lower region of the fryer tank. This makes it not only difficult to effect visual inspection of the base of the interior of the fryer but also equally difficult to access and remove the solid submerged food waste through the top of the fryer.

Even where drain holes are provided of more generous proportions, it is not generally practicable or possible to remove the submerged food waste and scraps by this means. Existing oil filtering systems are typically gravity operated with the hot cooking oil being allowed to drain from the fryer via a drain line and then through a filter element. However, systems are known that clean cooking oil by pumping it through a filter assembly often containing filter paper or other disposable filter media.

A filter powder may be dispersed in the cooking oil to accumulate and form a filter cake on the filter media thereby assisting to mechanically strain suspended solids from the liquid. Filter powders commonly consist of diatomaceous earth, perlite or other filter powders which are made up of various chemical mixtures which if in contact with the pump, may result in reduced pump life and efficiency.

Disposable filter elements such as paper, are an additional cost and may require regular disassembly of the filter assembly to replace the filter element. Tears or other voids in filters may result in particulate matter and filter powder accumulating on heating elements and additional contamination of the cooking oil.

The filtration processes described above are generally disruptive of business, messy and dangerous due to the need to carry out the work near high frying temperatures (130-160C) at which point the viscosity is low enough for the cooking oil to readily pass through known filter elements.

### SUMMARY OF THE INVENTION

Broadly according to one aspect of the invention there is provided cleaning and oil filtering apparatus for removal of all solid waste material from a container generally containing hot cooking oil and for filtering said cooking oil, including a pump, by which said cooking oil can be moved through an intake means insertable to the bottom of said container, a holding tank for temporary storage of cooking oil filtered through the filtering means, and a discharge means insertable in said container and through which cooking oil from the holding tank can be discharged or cooking oil from said container can be moved through said intake means and filtering means and discharged to said container.

According to a second broad aspect there is provided a method to remove solid waste material and filter hot cooking oil contained in a fryer, said method including the steps of removing oil from a fryer via an intake wand inserted in the fryer, filtering the removed oil and returning filtered oil to the substantially empty fryer to facilitate removal of waste material to said intake wand.

According to a third broad aspect there is provided a method to remove solid waste material and filter hot cooking oil contained in a fryer, said method including the steps of simultaneously removing solid waste material and oil from the fryer via an intake wand inserted in the fryer, filtering the removed oil and moving same to a holding tank, thereafter polishing said filtered oil from the holding tank through primary filtering means and returning polished oil to the fryer to facilitate removal of waste material to said intake wand, refiltering said polished oil and then returning oil held in the holding tank to said fryer.

### BRIEF DESCRIPTION OF THE DRAWINGS

In the following more detailed description of the invention, reference will be made to the accompanying drawings in which:—

FIG. 1 is a schematic illustration of the filtering apparatus according to the invention,

FIG. 2 is a perspective view of a preferred embodiment of the present invention,

FIG. 3 is a cross sectional view of a primary filter housing, the drawing also showing in exploded view, certain components of the primary filter housing,

FIG. 4 is a perspective view of filter bag press,

FIG. 5 is a cross sectional elevation through a pre-filter housing,

FIG. 6 is a plan view of the pre-filter housing shown in FIG. 5,

FIG. 7 is a cross sectional elevation through an intake wand with insulated handle,

FIG. 8 is a plan view of the intake wand as shown in FIG. 7,

FIG. 9 is a perspective view of an adjustable wand mounting assembly,

FIG. 10 is a perspective view of the discharge wand,

FIG. 11 is a perspective view of an oil displacement cylinder for optional use in the primary filter housing,

FIG. 12 is a plan view of a tool to remove blockage from the intake flexible hose, and

FIG. 13 is a perspective view of a drip catcher, and

FIG. 14 is an elevation view of an electrical control panel of the apparatus.

### DESCRIPTION OF PREFERRED EMBODIMENTS

According to the invention there is disclosed a method and apparatus to facilitate the cleaning of a vessel containing a liquid e.g. cooking oil. The method includes removing the liquid from that vessel and then utilising the liquid to suspend and convey all remaining undissolved contaminants (of whatsoever reasonable dimensions as are commonly encountered), from the vessel.

In the preferred embodiment, the apparatus is constructed substantially of stainless steel. It is designed to universally facilitate the rapid and efficient removal of all food scraps and undissolved particles associated with the deep frying of food, from the diverse and variously constructed deep fryers (cooking vats) currently in use within the commercial food industry.

The apparatus also effectively and efficiently provides for the filtration of the cooking oil contained in the vessel, such that the device may be configured in a light weight portable manner and utilised to enable a professional, commercial deep fryer cleaning and cooking oil filtering service.

The invention includes a pump to withdraw hot cooking oil and all suspended solids from a fryer by means of an intentionally unrestricted large bore intake wand. The oil then passes through a flexible hose into a pre-filter vessel containing a disposable fabric bag filter which as required, may be capable of removing food scraps and particulate down to approximately 50 micron.

After the largest suspended solids have been removed by the fabric bag filter, the cooking oil traverses the pump and is directed under low pressure into a primary filter vessel containing a pressure gauge, and a final polishing filter. On exiting the polishing filter, the filtered cooking oil may then be directed by a three way valve either into a holding tank, or returned back into the fryer by means of a flexible discharge hose and wand.

The method incorporates removing, filtering and transferring almost all of the cooking oil contained in the fryer into the holding tank. Thereafter, any food scraps still present in the fryer may be quickly removed by recycling the remaining cooking oil in the fryer through the filtration system described above by means of the intake and discharge wands until all visible contaminants have been removed from the fryer.

The flow of filtered cooking oil returned to the fryer through the discharge wand enables any remaining food scraps to be dislodged and suspended in the flow of cooking oil across the bottom of the fryer, which can then be directed to and withdrawn by means of the intake wand. To achieve this, the volume of cooking oil flowing from the discharge wand must equal that which is withdrawn by the intake wand. The discharge wand therefore is preferably constructed of pipe of narrower bore, relative to the intake wand, so as increase the fluid discharge velocity and enhance the cleaning achieved by the cooking oil as it is returned to the fryer.

An adjustable arm is provided on which to temporarily mount both wands about the fryer during use.

To return the cooking oil in the holding tank, a second three way valve is provided to enable cooking oil from the holding tank to also be fed directly to the pump. Both three way valves provide for the drainage of the pipe system through a separate drain valve located adjacent to the pump.

The two stage filtering system is fabricated from commercially available components and filter media and ensures that where treating material is not utilised, a high flow rate at low filtration pressures is achieved.

The pre-filter housing contains the aforementioned disposable fabric bag filter of large holding capacity.

The primary filter housing is configured to accept a disposable fabric bag filter which should be capable of removing particulate in the 1-5 micron range.

The open end of the filter bag contains a wire ring. Above the ring is a sprung loaded steel washer which under the influence of two compression springs, positively locates and seals the wire ring (and hence the open end of the filter bag) against the flange seat provided around the inside of the wall of the primary filter housing.

Other commercially available filtration components having substantially the same capabilities, ease of cleaning and economic viability as described above, may be substituted for any part or all of the filtering system set forth or may be additionally deployed to create a multistage filtering system for the purposes described herein.

An electrical panel provides a speed controller to regulate the motor and pump, a switch to override the trigger switch on the insulated handle of the intake wand, a motor reversing switch and a high voltage ‘on/off’ switch.

The device is of suitable weight displacement and external dimensions to facilitate movement in and through confined spaces, including vehicle access by means of suitably placed moving handles, and may be configured to accept stair mounting wheels.

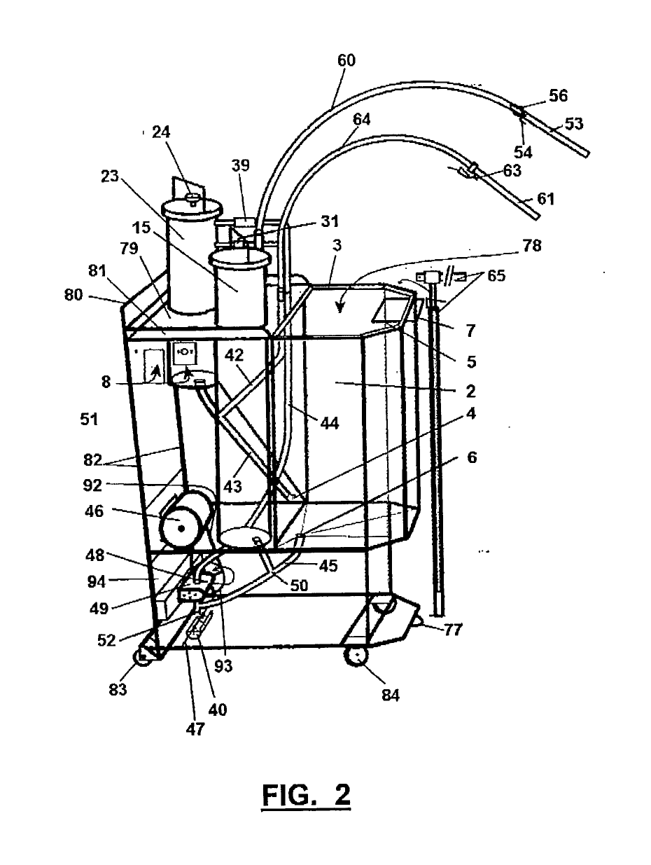

To more fully describe a preferred embodiment, reference is first made to FIG. 2. A handle 80 is fixed to frame 82, the latter being substantially constructed of square section stainless steel tubing. On the frame 82 is disposed drip tray 79 which creates a sealed upper surface to the apparatus for the protection and ease of cleaning of the electrical and other equipment located beneath.

Upstand 81 is provided around three sides of the perimeter of drip tray 79. This contains any spilt cooking oil which may then be safely directed into holding tank 2 located at the unrestricted side of drip tray 79.

Disposed through drip tray 79 is pre-filter housing 15, primary filter housing 23, pipe 42, and pipe 44. The pre-filter housing 15 is in communication with an intake wand 53 by means of flexible hose 60 and pump 49 by means of pipe 45 and three way valve 50. Mounted atop primary filter housing 23 is pressure gauge 24.

The primary filter housing 23 is in communication with

pump 49 by means of check valve 39 or two way ball valve 31 and pipe 44;

discharge wand 61 by means of flexible hose 64, pipe 42, three way valve 51 and pipe 43; and

holding tank 2 by means of three way valve 51 and pipe 43.

Intake wand 53 is preferably formed from not less than 32 mm OD stainless steel round tube having insulated handle 56 mounted thereon.

Flexible hose 60 is preferably formed from not less than 37 mm ID convoluted PTFE tubing with single stainless steel braid.

Discharge wand 61 is preferably formed from not less than 25 mm OD stainless steel round tube, having insulated handle 62 mounted thereon.

Flexible hose 64 is preferably formed from not less than 18 mm ID convoluted PTFE tubing with single stainless steel braid.

Pipe work is preferably formed from not less than 25 mm OD stainless steel round tube.

Electrical control panel 8 is located to provide convenient access to control electric motor 46. Motor 46 is coupled to pump 49 by means of small pulley wheel (not shown), single V belt 92 and large pulley wheel 93 and mounted on a steel plate 94 fixed to frame 82. Motor 46, is preferably 4 pole three phase and 375 watt.

Large pulley wheel 93 is equipped with drive nut 48 fixed to the end of the drive shaft of pump 49, to which a socket and bar may be attached to free pump 49 should it become seized with congealed fat. When not in use, drive nut 48 is covered by a protective skirt panel (not shown).

Pump 49 is a gear pump which may be equipped with a pressure by pass valve (not shown), and capable of reliably withstanding the high fluid temperatures encountered (approximately 200C maximum) and the abrasion of cooking oil treatment filter aids and particles of food waste. In the preferred form it is capable of delivering a fluid flow rate of 50 litres per minute or thereabouts under normal operating conditions.

Holding tank 2 is preferably of at least 50 litres capacity. It contains a holding tank discharge filter 6, an extension 4 of pipe 43 and wand transit mount 5. The bottom surface of holding tank 2 is fluted to facilitate complete drainage of cooking oil into the outlet orifice into which is inserted holding tank discharge filter 6. This filter 6 includes a perforated tube or perforated flat sheet providing protection to pump 49 from damage by hard extraneous objects inadvertently entering holding tank 2.

When the apparatus is transported in “standard mode” with handle 80 and motor 46 positioned flat against the tray of a transportation vehicle, the extension 4 of pipe 43 into holding tank 2 prevents residual cooking oil held therein from re-entering pipe 43.

Splashes from cooking oil held in holding tank 2 are contained by a fluid retaining lip 3 which also prevents leakage of any residual cooking oil when the apparatus is transported in the “standard mode”.

When not in use, intake wand 53 and discharge wand 61 are mounted on wand transit mount 5 by means of mounting hooks 54 and 63 respectively and retained in position by a cord (not shown). The cord has one end attached permanently and one end attached removably to handle 7 which is mounted externally at the top of the front face of holding tank 2. Handle 7 facilitates manoeuvring of the apparatus during use.

Wand support mechanism 65 is mounted externally on the left hand front corner face of holding tank 2 to provide continuously adjustable mounting for intake wand 53 and discharge wand 61 when in use.

A tool box (not shown) is mounted within the upper open aperture 78 of holding tank 2 for convenient access. The tool box may be fashioned to cover and protect the open aperture 78 from the entry of extraneous objects when the apparatus is not in use, or a separate cover (not shown) may be fabricated for the purpose.

Rear wheels 83 may be of the stair mounting variety or simple fixed wheels mounted at an angle to the horizontal so as to protrude to the rear of the frame and facilitate mounting of closed stair risers. Non-floor marking impact absorbing tyres (particularly suitable pneumatic tyres) are preferred. Front wheels 84 are preferably of the lockable swivel castor type equipped with non-floor marking (pneumatic) impact absorbing tyres.

D handle 77 at the lower front of the apparatus assists with lifting the front of the apparatus in order to rotate the apparatus onto a transport tray of a vehicle to achieve “standard mode” transportation.

All pipe work is configured to provide maximum fall to enhance free and thorough drainage of cooking oil whether the apparatus is in the attitude enabling use or in “standard mode” transportation, to thus avoid fat (oil) collecting within the apparatus to cause obstructions if such collections then solidify at low ambient temperatures. Drain valve 52 is installed at the lowest point of the pipe system yet with sufficient clearance to allow a drip catcher 40 to be mounted thereunder on mounting rod 47.

All components are constructed and finished to meet food handling safety standards.

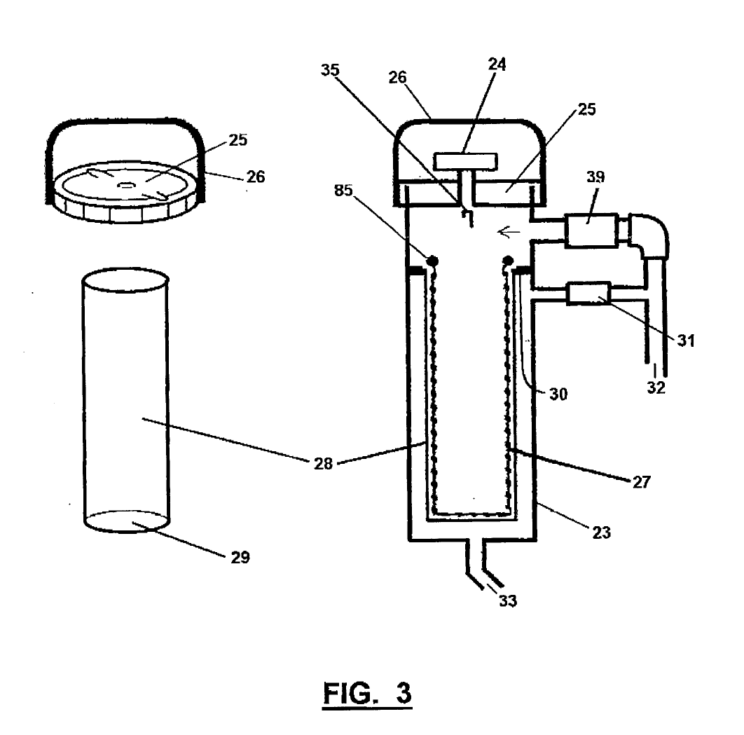

Referring to FIG. 3, there is shown a primary filter assembly in which a disposable filter bag 27 is contained in a perforated stainless steel support tube 28 having a solid base 29. The upper edge of support tube 28 is contained within and welded to flange 30 which is disposed around and welded to the inner wall surface of filter housing 23.

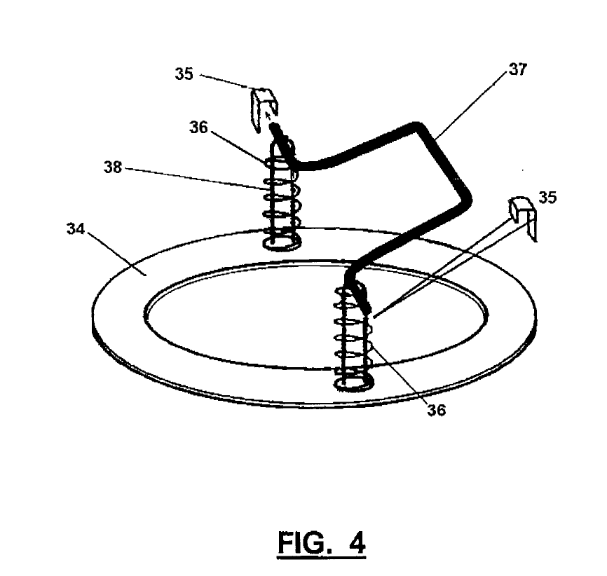

Mounting tabs 35 (two in number) are fixed to the upper inner wall surface of filter housing 23. These provide means by which compression springs 36 (see FIG. 4) may exert downwards pressure against filter bag press washer 34 (see FIG. 4) to compress and seal the upper edge of filter bag 27 containing wire ring 85 against flange 30.

Cooking oil enters primary filter housing 23 by intake 32 and passes through check valve 39, to then be filtered by filter bag 27 before exiting filter housing 23 through the discharge orifice 33.

Check valve 39 provides an enhanced safety feature such that when electric motor 48 is switched off, (see FIG. 2) hot cooking oil under pressure within the primary filter bag 27 is prevented from being returned through pipe 44, pump 49, pipe 45 and three way valve 50 to either enter holding tank 2 and possibly come forcibly and dangerously into contact with the operator of the apparatus or to return with contaminants to the fryer 1 by means of pre-filter housing 15, flexible hose 60 and intake wand 53.

At the discretion of the operator, cooking oil delivered through intake 32, may also be directed to separately enter primary filter housing 23 by means of two way ball valve 31. Oil thus entering primary filter housing 23 bypasses filter bag 27 and becomes available for use to remove blockages occurring beyond discharge orifice 33.

Pressure gauge 24 and handle 26 are mounted on the lid assembly 25, which threadedly attaches to filter housing 23 and retains a synthetic seal (not shown) disposed around the upper perimeter of filter housing 23.

In FIG. 4, a filter bag press is shown which comprises two compression springs 36 disposed around retaining guide rods 38 and welded to the upper surface of filter bag press washer 34. Compression springs 36 are retained under removable handle 37, the ends of which are constrained laterally and vertically by retaining guides 38.

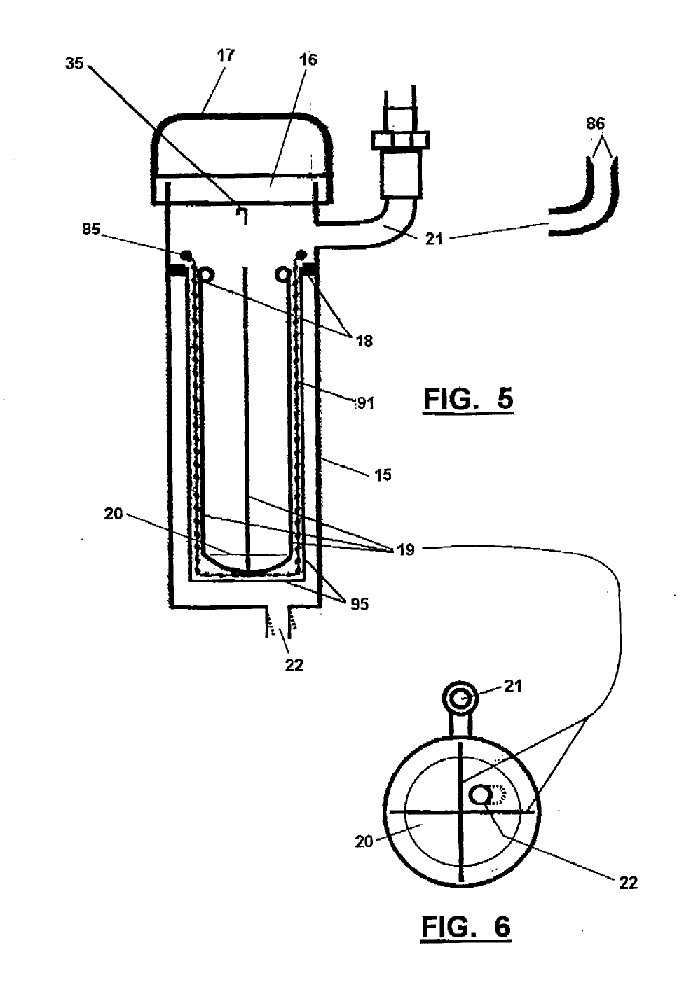

Pairs of mounting tabs 35, are set opposite each other at a suitable height above flanges 30 or 18 and separately welded to the inside of the primary filter housing 23 and pre-filter housing 15 (see FIG. 5). When the ends of removable handle 37 are engaged within mounting tabs 35, the springs are compressed and pressure thus exerted, engages press washer 34 against wire ring 85 to seal filter bags 27 or 91 (see FIG. 5) against respective flanges 30 or 18.

By disengaging removable handle 37 from mounting tabs 35, the filter bag press may be removed from primary filter housing 23 or pre-filter housing 15 for cleaning purposes. This procedure similarly permits filter bags 27 or 91 to be withdrawn for cleaning or replacement.

Referring to FIG. 5, there is shown the pre-filter assembly. This includes a disposable filter bag 91 contained in a perforated stainless steel support tube 95 having a perforated base and capacity of approximately 5 litres. The bag can be a 78 um polyester cloth that is reversible, resistant to adhesion of contaminants to therefore require little maintenance other than emptying, reversing, a quick scape down to remove any adhesions and replacing in the perforated support tube 95 contained in the housing.

Within disposable filter bag 91 is disposed a wire support frame 19 having grip rings formed at the upper ends and a support disc 20 fixed within the base perimeter. Support frame 19 thus prevents deflation of filter bag 91 under reverse fluid flow conditions and facilitates removal of food scraps contained within filter bag 91 for disposal.

The upper edge of support tube 95 is contained within and welded to flange 18 which is disposed around and welded to the inner wall surface of pre-filter housing 15. The perforated base of support tube 95 is off set approximately 40 mm from the base of pre-filter housing 15. This ensures that filtrate extracted from cooking oil passing through filter bag 91, is subsequently rendered substantially drained of liquid cooking oil.

Mounting tabs 35 (two in number) are fixed to the upper inner wall surface of pre-filter housing 15. These provide means by which compression springs 36 (see FIG. 4) may exert downwards pressure against filter bag press washer 34 (see FIG. 4) to compress and seal the upper edge of filter bag 91 containing wire ring 85 against flange 18.

Cooking oil enters pre-filter housing 15 by intake 21 and passes through filter bag 91 and perforated support tube 95 before exiting housing 15 through discharge orifice 22.

Pipe work presenting leading edges to the incoming flow of cooking oil are machined 86 to reduce drag and thereby minimise the likelihood of blockages from food scraps and other particulate.

Handle 17 is mounted on lid assembly 16, which threadedly is attached to pre-filter housing 15 and retains a synthetic seal (not shown) disposed around the upper perimeter of pre-filter housing 15.

An intake wand handle (see FIG. 6) includes an insulated handle 56 bored through it's base to accept control cable conduit 58 in communication with trigger switch 59 mounted centrally in slip restraint plate 57. Insulated handle 56 is preferably fabricated from wood for thermal insulation purposes. It is contoured along it's face adjacent to flexible braided hose 60 to provide finger grips 89 for the convenience and safety of the operator. This effect is further enhanced by the provision of slip restraint plate 57, the same being fixed by suitable wood screws 87 to the upper face of insulated handle 56.

Insulated handle 56 is further bored through it's base to provide a stopped hole to accept mounting rod 55. The rod 55 is being secured by metal thread screws 88 or the like passing through insulated handle 56 and into or therethrough. The opposite end of rod 55 is welded to intake wand 53 adjacent to the junction with flexible hose 60.

Control cable conduit 58 enables thermally suitable cable (not shown) to communicate from the electrical control panel 8 to the trigger switch 59 which for purposes of safety, is of a type that assumes the electrically off position when finger pressure is released from it's operating button. Control cable conduit 58 is strapped at appropriate centres to flexible hose 60 by means of stainless steel cable clips (not shown).

An internal spring (not shown) is inserted to extend the full length of flexible intake hose 60 to prevent the vacuum created by pump 49 from collapsing the internal PRFE lining of the hose, should the intake end of the intake wand become blocked during use.

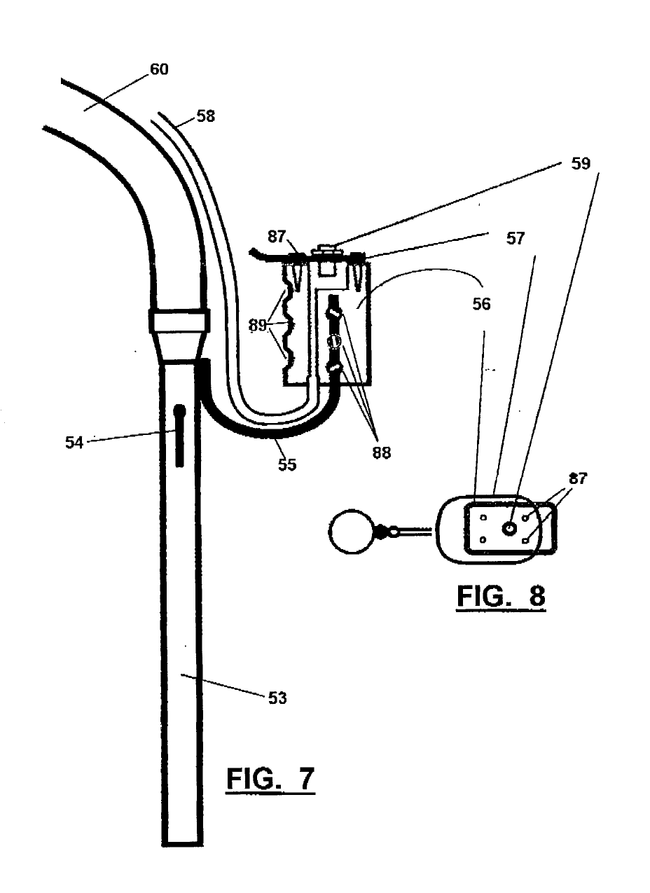

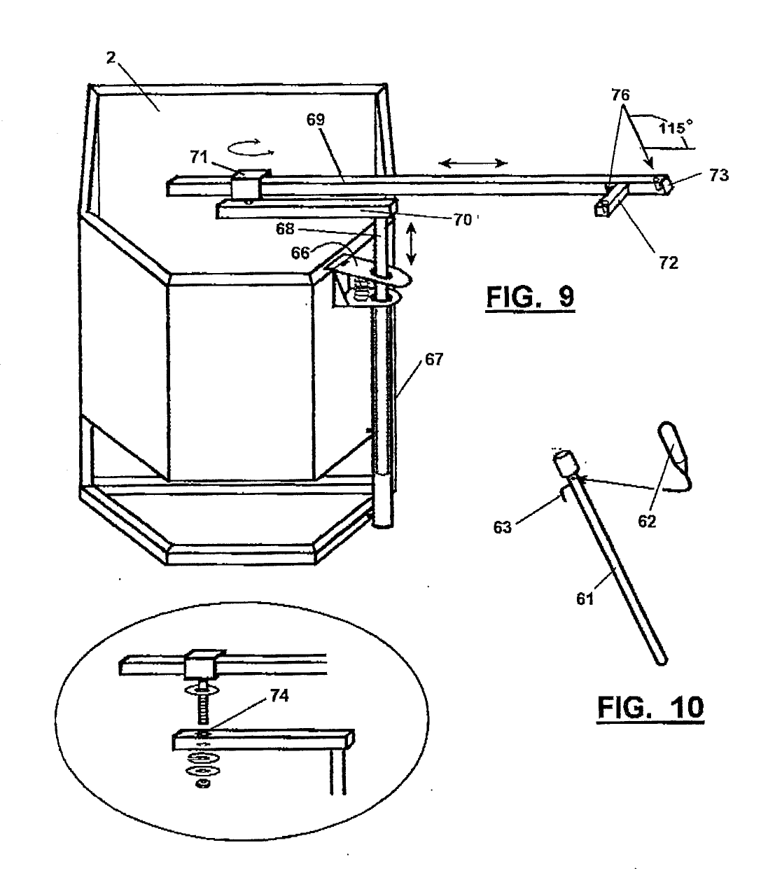

Mounting hook 54 is provided to secure intake wand 53 as required to either wand transit mount 5 or mounting estension 73 (see FIG. 7) located on wand support mechanism 65 (see FIG. 2).

Materials utilised, wall thicknesses and dimensions are chosen and fashioned to achieve lightness of weight for operator comfort.

Referring to FIG. 7, there is shown a discharge wand and mounting assembly. The discharge wand 61 incorporates insulated handle 62 preferably fabricated from wood to achieve suitable thermal insulation. Discharge wand 61 is disposed on mounting extension 72 preferably at an angle of 25 degrees from the vertical by engaging mounting hook 63 into mounting hole 76.

Mounting extension 73 and further mounting hole 76 are provided to similarly and separately mount intake wand 53. Together with mounting extension 72 and mounting hole 76 they are adjacently located at the forward end of horizontal square tube 69, thus forming part of mounting assembly 65 (collectively shown) which comprises:—

1. The aforementioned mounting extensions 72 & 73 and mounting holes 76 (2)

2. Horizontal square tube 69

3. Horizontal square tube 70

4. Square sleeve 71

5. Fulcrum 74

6. Vertical round pivot tube 68

7. Height adjustment 66

8. Mounting sleeve 67

Horizontal square tube 69 is able to slide continuously along it's length within square sleeve 71. It thus provides means by which mounting arms 72 and 73 can be extended forward beyond the front of the apparatus to suitably mount discharge wand 61 or intake wand 53 into fryer 1 (see FIG. No 1).

Square sleeve 71, is mounted on fulcrum 74, located adjacent to the rear facing extremity of horizontal square tube 70. The forward facing extremity of horizontal square tube 70 is fixed atop vertical round pivot tube 70 which is free to continuously rotate within mounting sleeve 67.

As vertical round pivot tube 70 is rotated, horizontal square tube 70 also rotates on it's pivot point atop vertical round pivot tube 70. When in use, horizontal square tube 70 is preferably but variously positioned at 90 degrees from the side of holding tank 2. Square sleeve 71′ and fulcrum 74 are thus similarly and if required, adjustably offset from the side of holding tank 2.

Upper horizontal square tube 69 is retained at it's rear facing extremity within square sleeve 71. It is similarly offset from the side of the apparatus, yet still able to rotate on fulcrum 74. By utilising the rotation of square sleeve 71 and the longitudinal travel of upper horizontal square tube 69 within square sleeve 71, it is possible to variably and conveniently position discharge wand 61 or intake wand 53 in the fryer 1 from an offset angle by means of wand support mechanism 65. Thus it allows the operator unimpeded working space in front of the apparatus and along and behind the front wall of the fryer 1.

Vertical round pivot tube 70 may also be continuously adjusted along it's length to correspondingly affect the height of the horizontal components of the wand support mechanism 65. Height adjustment is secured by means of height adjustment mechanism 66 whereby vertical round pivot tube 68 is passed through a hinged flat upper tab that is spring loaded downwards to interfere by friction with the downwards travel of vertical round pivot tube 68 in mounting sleeve 67. As the upper tab is increasingly rotated downwards from a disengaged horizontal position, so also is vertical round pivot tube 68 increasingly deflected against the inner surfaces of both mounting sleeve 67 and the upper tab, thus preventing it's further descent.

Mounting sleeve 67 is fixed to the left hand front face of holding tank 2 such that when in parallel alignment, the left hand side face of horizontal square tubes 69 and 70 can be longitudinally positioned adjacent to and inside upstand 81 at the left hand edge of drip tray 79.

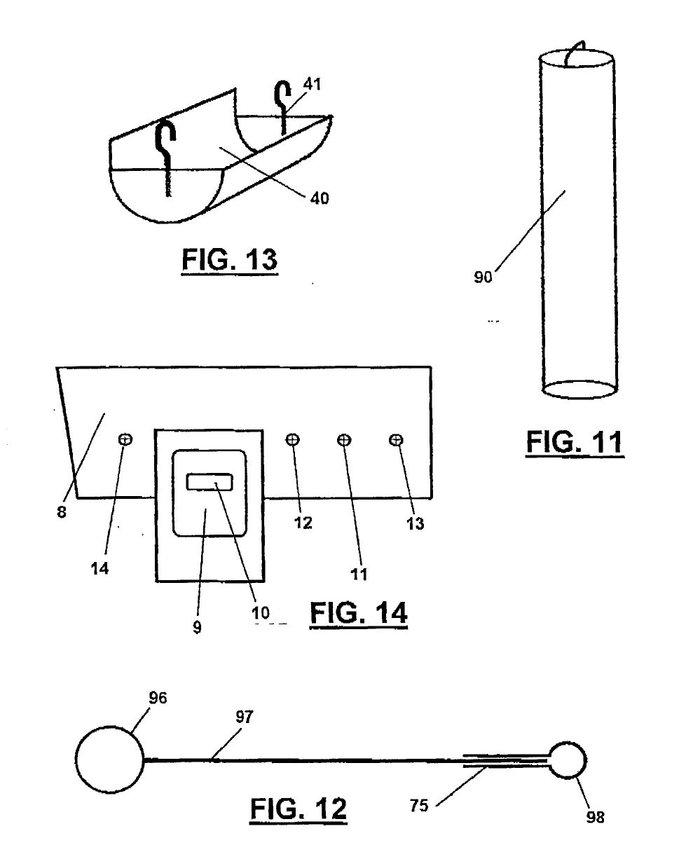

Referring to FIG. 11 a sealed cooking oil displacement cylinder 90 is shown for optional use with primary filter bag 27, to minimise the amount of cooking oil retained in filter bag 27 when being withdrawn from primary filter housing 23 for cleaning or replacement.

Intake hose cleaner 75 is schematically shown in FIG. 12 comprising round wire rod handle 96, suitable length of flexible spiral wire tube 97 and circular wire rod cleaning head 98. The cleaning head 98 is inserted into intake wand 53 to reach and dislodge food scraps found therein.

A drip catcher 40 is shown in FIG. 13 and is capable of receiving residual discharge from the apparatus by means of drain valve 52 after initial drainage of the pipe work and vessels of the apparatus. Mounting hooks 41 are attached to mounting rod 47, enabling drip catcher 40 to thereby remain perpendicularly beneath drain valve 52, irrespective of whether the apparatus is in use or in “standard mode” transportation. Without limitation, drip catcher 40 is primarily intended for deployment as soon as the apparatus has been placed in “standard mode” transportation.

The electrical control panel is depicted in FIG. 14 and contains speed control device 9 capable of continuously varying and maintaining the speed of motor 46. Additionally, for safety purposes, speed control device 9 is able to ramp the attainment of a given increased speed setting according to prior adjustment and optionally to stop and to apply an electrical brake to motor 46 immediately upon initiation by the operator. Thus control of unwanted or unexpected discharge of cooking oil from the apparatus under the influence of mechanical energy or fluid pressure transferred to the pump 49 can be achieved.

The following additional controls are mounted in electrical control panel 8:—

1. Trigger override switch 12 which enables the operator to carry out certain functions such as to empty holding tank 2 into fryer 1 without being constrained to hold and operate trigger switch 59 which in this instance, when discharge wand 61 is suitably mounted on mounting arm 72 leaves the operator free to carry out other duties.

2. Speed control knob 11 provides analogue speed control in preference to digital microswitch speed adjustment.

3. LCD display 10 provides visual means to accurately determine the speed of electric motor 46.

3. Master on/off switch 13 enables the operator to switch the mains power supply to the apparatus.

Reversing switch 14 provides for the reverse operation of motor 46 to facilitate clearing blockages or draining pipe work.

To assist in the further understanding of the construction of the apparatus according to the present invention, reference will be made to the methodology used when cleaning oil from a fryer.

The temperature of the cooking oil in fryer 1 is adjusted to approximately 160° C. and then the heat turned off. The operator then removes the element protection tray or mesh using a stainless steel wire hook or pliers or similar. Where appropriate, electric elements are also withdrawn.

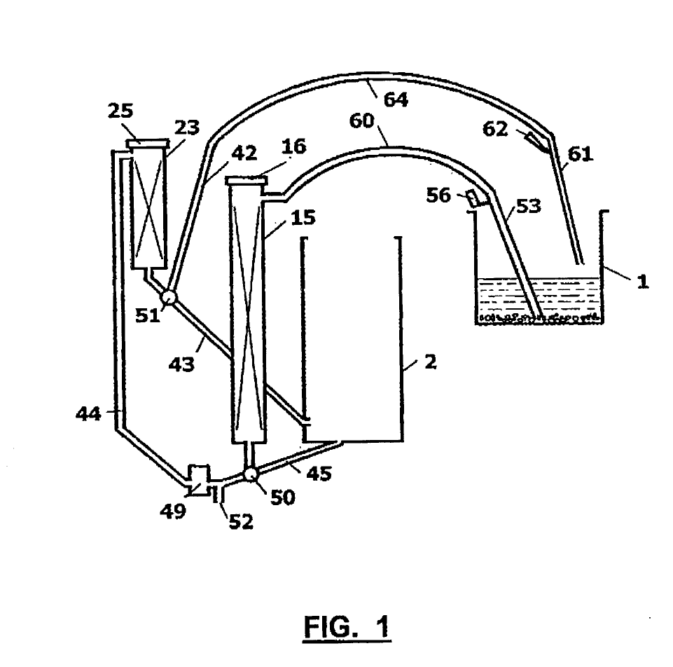

As shown in FIG. 1 the intake wand 53 and discharge wand 61 are inserted into the fryer 1 on the wand support mechanism 65 with the open ends of the wand set as near as practicable to the bottom but clear of any fixed electric elements, temperature sensors or other obstructions. The drain valve 52 and two way ball valve 31 are then turned off and lids 25 and 16 of filter housings 23 and 15 are securely fastened to form suitable fluid seals.

Valve 50 is set to direct cooking oil from fryer 1 to pump 49 by means of intake wand 53, flexible hose 60, pre-filter housing 15 and the balance of pipe 45. Valve 51 is set to direct cooking oil from pump 49 to holding tank 2 by means of pipe 44, check valve 39, primary filter 23 and pipe 43. The speed control device 9 on control panel 8 is adjusted by means of speed control knob 11 to operate motor 46 at high speed.

Actuation of trigger switch 59 on intake wand handle 56 activates motor 46 which is coupled to pump 49 thereby enabling the operator to manipulate the intake wand 53 and vacuum out virtually all of the cooking oil in fryer 1 to the holding tank 2. At the same time the operator endeavours to withdraw as much food scrap from the bottom of the fryer 1 as possible. When this operation is completed, the pump 49 is stopped and the intake wand 53 is returned to the wand support mechanism 65.

The operator then removes accumulated encrustations of food particles and carbon from the interior of the fryer one using a steel wire pad under hand pressure. Valve 50 is then set to direct cooking oil from holding tank 2 to pump 49 by means of pipe 45. Valve 51 is adjusted to direct cooking oil from pump 49 along pipe 44 to primary filter 23 thence to fryer 1 by means of pipe 42, flexible hose 64 and discharge wand 61. By manipulating the speed control knob 11 on electrical control panel 8, the speed of motor 46 can be adjusted to “very slow”.

By utilising trigger override switch 12, flow of filtered cooking oil is initiated from the discharge wand 61, so that the cooking oil is discharged to wash the dislodged encrustations adhering to the internal wall surface thereof to the bottom of the fryer 1. In so doing the operator ensures that sufficient cooking oil is returned to the fryer to provide a fluid seal at the end of the intake wand 53 as subsequently required.

The trigger override switch 12 is then turned off. The speed control knob 11 is then adjusted to operate pump 49 at high speed and valve 50 set to withdraw cooking oil from the fryer 1 to pump 49. This is achieved through intake wand 53, flexible hose 60, pre-filter housing 15 and pipe 45.

By holding insulated handle 62 of discharge wand 61 in one hand (e.g. the left hand) and then holding the intake wand handle 56 in the other hand, the operator presses trigger switch 59 to operate pump 49 at high speed. The operator can thus use filtered cooking oil from discharge wand 61 to wash clean the bottom of the fryer and electric elements (if any) and jet the remaining food scraps and other waste material towards and into intake wand 53. This technique is used to remove all remaining food scraps and wastes from the fryer.

When fryer 1 is visually free from food scraps and waste, pump 49 is kept running while the operator returns the discharge wand 61 to the wand support mesh mechanism 65 and then adjusts Valve 51 to redirect cooking oil to the holding tank 2 by means of pipe 43 and proceeds to withdraw as much oil as possible from holding tank 2.

Thereafter the operator holds intake wand 53 aloft and catching any dripping cooking oil or discharge in a stainless steel jug, moves it to a point above the holding tank 2. By maintaining the intake wand 53 above holding tank 2 and clear of the cooking oil, the pre-filter system 15 in particular is drained of cooking oil, achievement of which is evidenced by the emergence of air bubbles into holding tank 2 from the end of pipe 43. The pump 49 can then be stopped and the intake wand 53 attached to wand transit mount 5 by means of mounting hook 54.

Resetting valve 50 enables the return of cooking oil from holding tank 2 to the fryer 1 by means of pipe 45, pump 49, pipe 44, check valve 39, primary filter 23, pipe 43, valve 51, pipe 42, flexible hose 64, and discharge wand 61. This action is initiated using override switch 12.

While the fryer 1 is refilling, the wand support mechanism 65 is lifted to set discharge wand 61 above and clear of the final level of cooking oil in the fryer. Food scraps and waste contained in filter bag 91 within pre-filter 15, can then be emptied.

When the holding tank 2 is empty, operations of pump 49 is continued until the primary filter housing 23 has been to the extent possible, fully drained into the fryer. As required, the operator can then replace filter bag 27 with a clean filter bag. The discharge wand 61 is then returned to the wand transit mount 5 in holding tank 2 by means of mounting hook 63 and secured together with intake wand 53. The wand support mechanism 65 is then folded away and secured.

Operation on the fryer is completed by reassembling the fryer and cleaning its exterior.

The operator will then drain the apparatus by setting valve 50 and 51 to their common drain position, and opening drain valve 52 at pump 49 to then capture discharging cooking oil in a stainless steel jug. When holding tank 2 and pre-filter 15 have drained, pump 49 is operated in reverse using reversing switch 14. This drains pipe 44. Any cooking oil recovered is returned to the fryer following which the drain valve 52 is closed.

This completes the cleaning operation whereupon the power cord to the apparatus can be disconnected and the apparatus and tools etc, packed up. The apparatus can then be returned to a transport vehicle. By grasping D handle 77 and lifting and rotating the apparatus and sliding it upon the rear surface of frame 82, the apparatus can be positioned and separately secured onto a vehicle transport tray. Drip catcher 40 is then mounted on mounting rod 47 and drain valve 52 opened so residual cooking oil in the apparatus may continue to drain during transit.

When cleaning multiple fryers, it is not necessary to return intake wand 53 to wand transit mount 5 before moving the apparatus from one fryer to the next. The operator simply remounts intake wand 53 onto wand support mechanism 65 and raises the whole assembly so that both wands 53 and 61 clear the top of the fryer as the apparatus is wheeled to the next fryer.

Then, where the chef is agreeable, the apparatus enables the operator to more quickly clean a series of adjacent fryers by eliminating the need to pump the cooking oil from any fryer twice, except for oil contained in the first one. This is achieved by emptying the first fryer into the holding tank 2 and then pumping the cooking oil in the second fryer, directly into the first fryer and so on and so forth.

To those skilled in the art it will be apparent that the preferred form of the invention and method of use is open to modification. For example:—

The apparatus may be utilised to rapidly remove spent cooking oil and food waste from a fryer by adjusting the three way valves so that said oil bypasses the primary filter, enabling the partially filtered cooking oil to be discharged more directly into a suitable waste container.

The components within the pre-filter housing may be modified by equipping the open end of the perforated tube with a flange and upward facing handles to enable said flange to removably seat atop and seal against the flange disposed around the inside of the pre-filter housing. The perforations in the tube would be reduced in size to satisfactorily strain larger food particles from the cooking oil passing therethrough. The strainer basket thus created, would have a capacity to hold approximately litres of such food particles.

An intermediate filter may be incorporated within the primary filter housing to further extend the service life of the primary filter bag before cleaning becomes necessary.

As previously disclosed, cooking oil discharged from pump 49 may be utilised to remove obstructions occurring in the fluid pathway beyond primary filter housing 23, for which purpose and physical convenience, the facilitating valve is shown deployed between the intake pipe line to the primary filter and a hole inserted in the wall of the primary filter housing just below the internal flange. It will be apparent that other suitable fluid pathways are also possible.

The present invention thus provides a method and portable apparatus which can be used universally to simplify the cleaning of a fryer and effectively remove particulate material from the cooking oil. The amount of labour required to carry out this operation is less than would conventionally be required using known equipment.

The filtering operation can be carried out without the use of filter aid treatment powders which when sprinkled into the fryer to achieve even disbursement therethrough, may thereby generate airborne dust capable of inhalation. Such powders may contain silica, the inhalation of certain forms of which is considered a hazard to human health.

Nonetheless, the filtering operation may be carried out in conjunction with filter aid treatment powders although a coarser filtration mesh may require to be deployed in the pre-filter housing. The method and apparatus does not result in any contamination of the cooking oil by the treatment material.

The filtering operation can also be carried out together with technologies that reduce the level of free fatty acids which are known to increase during the cooking process, the presence of which degrades performance of the cooking oil.

The filtering apparatus employs substantially re-useable filter elements to provide for relatively economical filtering of cooking oil.

The apparatus provides facility to continuously vary the pump speed, which control enhances operator safety by enabling splash back from the discharge wand to be prevented when refilling the fryer. Also such variation and control of the pump speed provides the capability of safely washing contaminants from the walls of the fryer with a minimum discharge of cooking oil from the discharge wand. These and other safety features lead to the method and apparatus being able to be practised with safety of the operator in mind.

What is claimed is:—

1. Cleaning and oil filtering apparatus for removal of all solid waste material from a container generally containing hot cooking oil and for filtering said cooking oil, including a pump, by which said cooking oil can be moved through an intake means insertable to the bottom of said container, a holding tank for temporary storage of cooking oil filtered through the filtering means, and a discharge means insertable in said container and through which cooking oil from the holding tank can be discharged or cooking oil from said container can be moved through said intake means and filtering means and discharged to said container.

2. Apparatus as claimed in claim 1 including a mobile frame with which are mounted the filtering means, pump, holding tank and intake and discharge means, said mobile frame being locatable in a immobile transport position and a mobile position.

3. Apparatus as claimed in claim 2 wherein including first and second three way valves arranged such that in the fully open position, no additional oil can enter the pipe work which fully drains oil via a drain valve whether the frame is located in the immobile transport position or the mobile position.

4. Apparatus as claimed in claim 1 wherein the filtering means includes a pre-filter, a primary filter, a first three way valve and a second three way valve.

5. Apparatus as claimed in claim 4 wherein an intake means is connected to the pre-filter, the pre-filter being disposed in fluid communication with the discharge means by way of the three way “T” valve, pump, a check valve, primary filter and the second three way valve all arranged to permit movement of cooking oil from said pre-filter, through said primary filter to said discharge means.

6. Apparatus as claimed in claim 4 wherein an intake means is connected to the pre-filter, the pre-filter being disposed in fluid communication with the holding tank by way of the first three way valve, pump, a check valve, primary filter and the second three way valve all arranged to permit movement of cooking oil from said pre-filter, through primary filter to said holding tank.

7. Apparatus as claimed in claim 4 wherein the discharge means is connected to the primary filter via the second three way valve, the primary filter being disposed in fluid communication with the holding tank, via a check valve, pump and the first three way valve, all arranged to permit movement of cooking oil from said holding tank through said primary filter to discharge means.

8. Apparatus as claimed in claim 4 wherein the discharge means is in fluid communication with the holding tank, via the second three way valve, primary filter, a check valve, pump and the second three way valve, all arranged to permit movement of cooking oil from said holding tank through said primary filter and discharge means and return said cooking oil to said holding tank by said discharge means inserted in said holding tank.

9. Apparatus as claimed in claim 4 wherein the intake means is a wand connected to a conduit which extends to the pre-filter and the discharge means is a wand connected to a conduit which extends to the primary filter via the second three way valve.

10. Apparatus as claimed in claim 4 wherein the intake wand includes a control mechanism for control of the pump.

11. Apparatus as claimed in claim 10 wherein the control mechanism includes a switch associated with a handle of the intake wand and a control cable conduit which extends to an electrical control unit.

12. Apparatus as claimed in claim 4 wherein the primary filter includes a housing, pressure gauge, a disposable filter bag and a mounting for mounting an open upper end of the filter bag, a filter bag support tube, the housing having an inlet disposed radially above the open end of the filter bag and an outlet disposed below the lower end of the filter bag.

13. Apparatus as claimed in claim 12 wherein the primary filter further includes bypass means for oil to enter into the housing but bypass the filter bag.

14. Apparatus as claimed in claim 4 wherein the pre-filter includes a housing, a disposable filter bag, a filter bag support tube, a support frame located within the filter bag and a mounting for mounting an open upper end of the filter bag, the housing having an inlet disposed radially above the open end of the filter bag and an outlet disposed beneath a lower end of the filter bag.

15. Apparatus as claimed in claim 9 further including a mounting assembly for removably mounting and supporting the intake wand and discharge wand in the container, said mounting assembly being adjustable for the positioning of the intake and discharge wands in said container.

16. A method to remove solid waste material and filter hot cooking oil contained in a fryer, said method including the steps of simultaneously removing solid waste material and oil from the fryer via an intake wand inserted in the fryer, filtering the removed oil and moving same to a holding tank, thereafter polishing said filtered oil from the holding tank through primary filtering means and returning polished oil to the fryer to facilitate removal of waste material to said intake wand, refiltering said polished oil and then returning oil held in the holding tank to said fryer.

17. The method as claimed in claim 16, wherein the removed oil is passed through a pre-filter and primary filter to the holding tank, until substantially all the oil in the fryer resides in the holding tank, thereafter the removed oil in the holding tank is passed through the primary filter to the discharge wand and back into the fryer.

18. The method as claimed in claim 16 further including the steps of retaining the filtered oil in the holding tank until any remaining encrusted waste in said fryer can be manually dislodged.

19. The method as claimed in claim 18 further including the steps of moving a small proportion of said oil from the holding tank, polishing the removed oil in a primary filter and returning polished oil to the fryer via a discharge wand inserted in the fryer wherein the flow of oil from the discharge wand into the substantially empty fryer is used to wash dislodged encrustations adhering to the internal wall surfaces of the fryer to the bottom of the fryer.

20. A method to remove solid waste material and filter hot cooking oil contained in a fryer, said method including the steps of removing oil from a fryer via an intake wand inserted in the fryer, filtering the removed oil and returning filtered oil to the substantially empty fryer to facilitate removal of waste material to said intake wand.

21. The method as claimed in claim 20 further including the steps of continually removing oil from the substantially empty fryer via the intake wand inserted in the fryer, filtering the removed oil and returning the refiltered oil to said fryer to facilitate removal of waste material to the said intake wand, until the fryer and the oil contained in the fryer are free of contaminants.
